(19) United States
(12) Patent Application Publication
(10) Pub. No.: US 2007/0100827 A1
(43) Pub. Date: May 3, 2007

(54) Real-time data exchange system and method thereof

(76) Inventors: Lii-Haur Lu, Hsin-Tien City (TW); Yi-Zeng Yeh, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/506,802

(22) Filed: Aug. 21, 2006

(30) Foreign Application Priority Data
Oct. 27, 2005 (TW) 094137667

(51) Int. Cl. G06F 17/30

(52) U.S. Cl. 707/8

(57) ABSTRACT

A real-time data exchange system and method thereof are disclosed. A remote management system is connected to a first system, a second system and a shared database respectively. The remote management system is used to receive a plurality of data from the first system and stores the data to the shared database. At the same time, the data is real-time sent to the second system. Therefore, data exchange between different systems is controlled by the remote management system so as to avoid direct access of the database by different systems through internet or intranet.

### FIELD OF INVENTION

The present invention relates to a real-time data exchange system and a method thereof, especially to a remote management system and method for managing real-time data exchange of a shared database.

### BACKGROUND OF THE INVENTION

Due to rapid change of industrial environment, progress of communication technology, and trends of automation and digitalization, there are various systems developed inside or between companies. By increasing of different systems, different platforms, and back-end database between the systems, data sharing and exchanging become an important issue in companies.

Referring to FIG. 1, it shows data exchange between different systems. A first system 10′ reads and transmits data of a first database 12′ to a second database 20′ of a second system 18′ so as to update content of the second database 20′ that corresponds to the data read from the first database 12′. Although the above system overcomes problems of data exchanges among different systems, there might raise database security problems by direct database access operations, such as accessing data from the first system 10′ to the second system 18′ directly with security or authentication mechanism. On the other hand, if a user intends to steal data, there is no mechanism for verifying the user's ID for preventing any direct data accessing operation.

Besides the aforementioned security problem, it is inconvenient to classify the data to corresponding systems when the company system intends to transmit the data to a plurality of different systems. At the same time, a load of the first database 12′ also increases. An other approach for efficiently exchanging data among a plurality of different systems is to use a database as a communication medium.

Referring to FIG. 2, a conventional method for data exchange among different systems is shown. The first system 10′ reads and sends a plurality of data from the first database 12′ to a sharing database 14′ for updating corresponding data of the sharing database 14′. According to a schedule preset by a database scheduling unit 16′, the second system 18′ periodically reads the updated data of the sharing database 14′ for updating content of the second database 20′

FIG. 2 shows that the database is taken as a data exchange medium for heterogeneous systems. By periodically scheduling, the second system 18′ reads the updated data of the shared database 14′ at a scheduled time. Once the time lag between the scheduled time and the time that the data sent from the first system 10′ to the shared database 14′ is too long, the data exchange is not real-time. Thus there might be data inconsistency or data error between the first system 10′ and the second system 18′.

In accordance with above description, a conventional system and method for data exchange neither changes data in real time nor encrypts the data inside the database. Thus the data in the database may be stolen without data security mechanisms.

### SUMMARY OF THE INVENTION

A real-time data exchange system and the method thereof provides a remote management system to control data exchange process among different systems and execute data exchange in real time. Moreover, direct data access of the database among different systems is prevented for ensuring database security.

A real-time data exchange system discloses a first system connecting to a remote management system for transmitting a plurality of data. The remote management system connects to a shared database for storing the data. Then, the data is transmitted to a second system by the remote management system for updating the content of the second system in time when the data is stored in the shared database.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic drawing showing a conventional data exchange system;

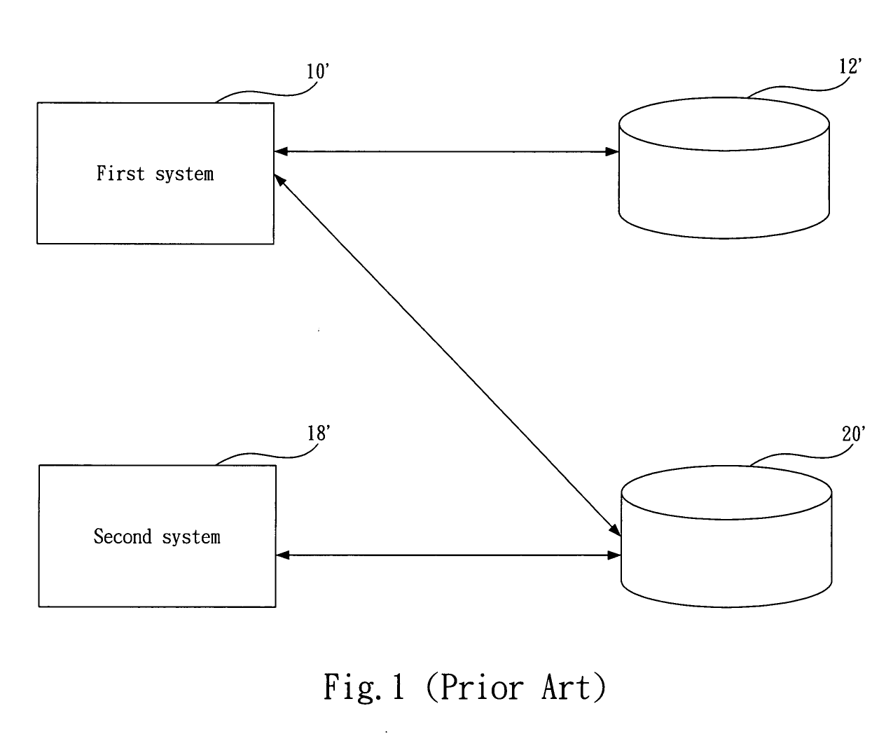

FIG. 2 is a schematic drawing showing another conventional data exchange system;

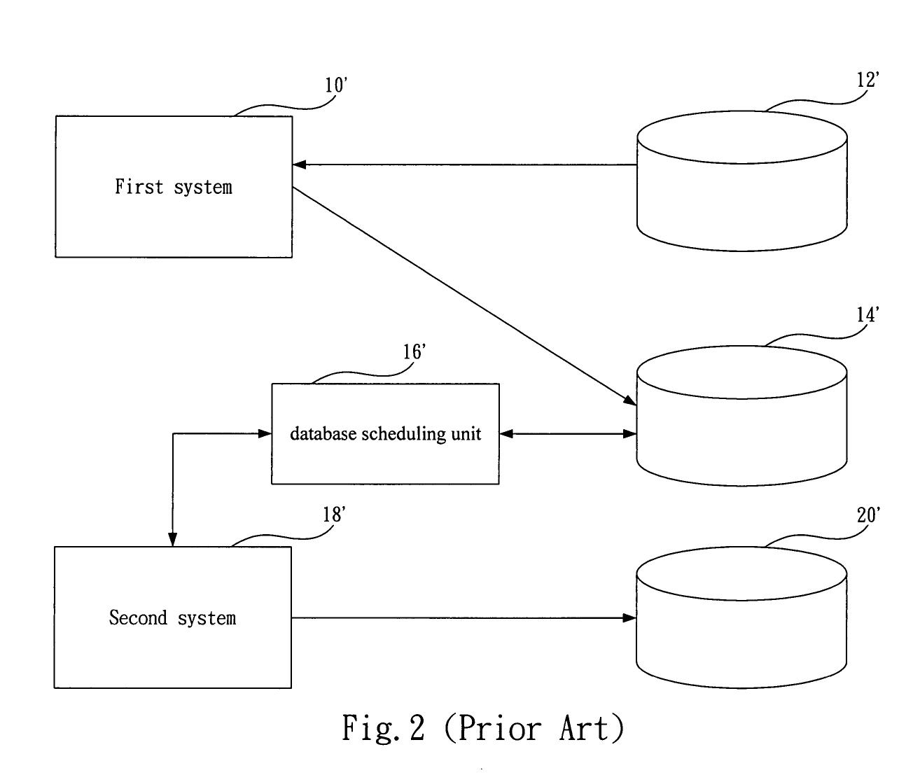

FIG. 3 is a schematic drawing of an embodiment in accordance with the present invention;

FIG. 4 is a flow chart of an embodiment in accordance with the present invention.

### DETAILED DESCRIPTION OF THE PREFERRED

### EMBODIMENT

The present invention provides a real-time data exchange system and method thereof that controls data exchange between different systems for real-time exchanging data and preventing direct data accessing operations to the database by different systems so as to ensure database securities.

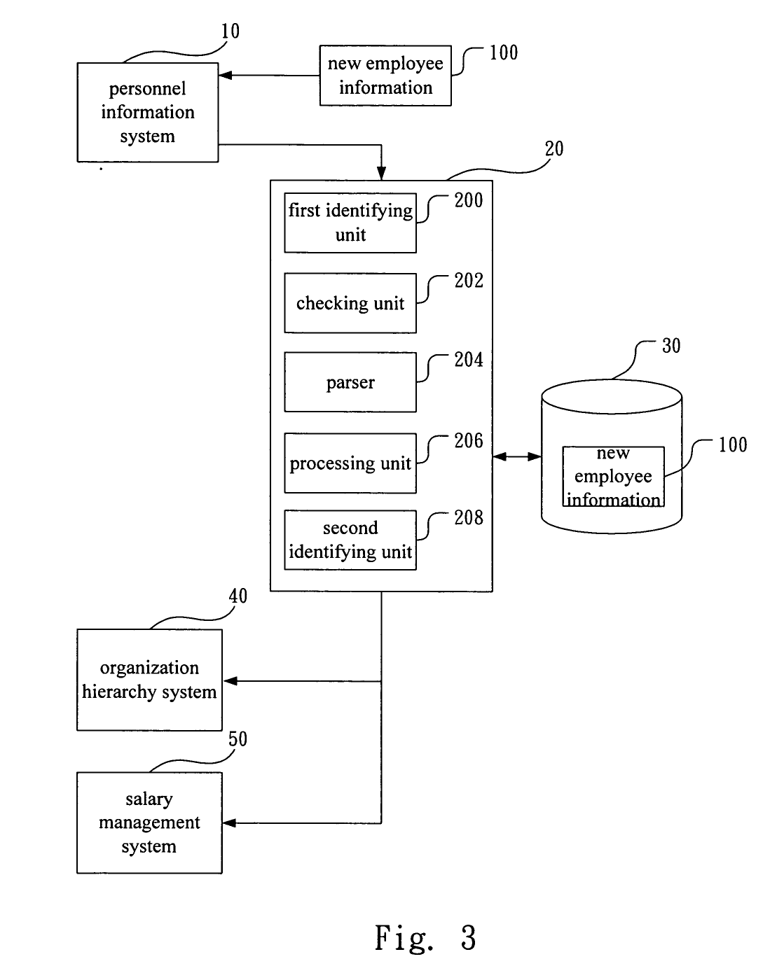

Referring to FIG. 3, the present invention includes a personnel information system 10, a remote management system 20, a shared database 30, an organization hierarchy system 40 and a salary management system 50. The remote management system 20 is respectively connected to the personnel information system 10, the shared database 30, the organization hierarchy system 40 and the salary management system 50 through the Internet or intranet.

When a user wants to update new employee information 100, the new employee information 100 is sent to the remote management system 20 and then stored into the shared database 30. Moreover, the remote management system 20 checks whether the organization hierarchy system 40 and the salary management system 50 are the subjects of the new employee information 100. Then the new employee information 100 stored in the shared database 30 by the remote management system 20 is transmitted into the organization hierarchy system 40 and the salary management system 50 so as to maintain data consistency between the personnel information system 10 and the organization hierarchy system 40 as well as the consistency between the personnel information system 10 and the salary management system 50.

The remote management system 20 includes a first identifying unit 200, a checking unit 202, a parser 204, a processing unit 206 and a second identifying unit 208. The first identifying unit 200 checks whether the personnel information system 10 is recognized by the remote management system 20 so as to prevent illegal systems to access the remote management system 20. When the new employee information 100 is transmitted to the shared database 30 by the remote management system 20, the checking unit 202 of the remote management system 20 checks service type of the new employee information 100 so as to verify whether the service type of the new employee information 100 corresponds to service type of the organization hierarchy system 40 and the salary management system 50. If not, the remote management system 20 rejects the new employee information 100 accessing. For example, when a user wants to update the new employee information 100 of the personnel information system 10 stored into the shared database 30, the new employee information 100 is sent to the checking unit 202 of the remote management system 20 for verifying whether service type of the new employee information 100 corresponds to service type of the organization hierarchy system 40 and the salary management system 50. If so, the new employee information 100 is sent to the shared database 30 by the remote management system 20 for updating the data stored in the shared database 30. If not, the new employee information 100 in the personnel information system 10 is rejected by the remote management system 20.

The parser 204 is used to analyze the new employee information 100 for recognizing its item name and the content. If the new employee information 100 is encrypted, it is decrypted by the parser 204. The processing unit 206 is set for processing executions between the remote management system 20 and the shared database 30 such as connection between the remote management system 20 and the shared database 30 for storing the new employee information 100 into the shared database 30 or converting the new employee information 100 stored in the shared database 30 into data with XML (Extensible Makeup Language) format for sending it into the organization hierarchy system 40 and the salary management system 50. The second identifying unit 208 is to identify whether the organization hierarchy system 40 and the salary management system 50 are subjects that the new employee information 100 is sent to. It is assumed that the organization hierarchy system 40 is not the subject of the new employee information 100, the second identifying unit 208 sends an undeliverable instruction to the personnel information system 10 through the processing unit 206. When the present invention is applied in the company, the first identifying unit 200 and the second identifying unit 208 can be removed because the systems are connected to different systems in the company through intranet. When the present invention is applied among different companies through internet, it is necessary to provide the first identifying unit 200 and the second identifying unit 208 for data security.

The management system 20 in accordance with the present invention uses data communication protocols such as Transmission Control Protocol/Internet Protocol (TCP/IP) as channels of data exchange for receiving the new employee information 100. TCP/IP uses the terms “socket” and “port” to describe the path (or virtual circuit) over which cooperating applications communicate. Socket means a logic address and a port. Within the TCP/IP environment, two systems communicate with each other by different port numbers. Compared with the communication protocol of HTTP with 80 Port, the TCP/IP is more flexible and fast. Moreover, in order to make different platforms communicate with each other through network, the remote management system 20 in accordance with the present invention can be a web server so that the personnel information system 10, the organization hierarchy system 40 and the salary management system 50 connect to the remote management system 20 by the explorer for real-time data exchange.

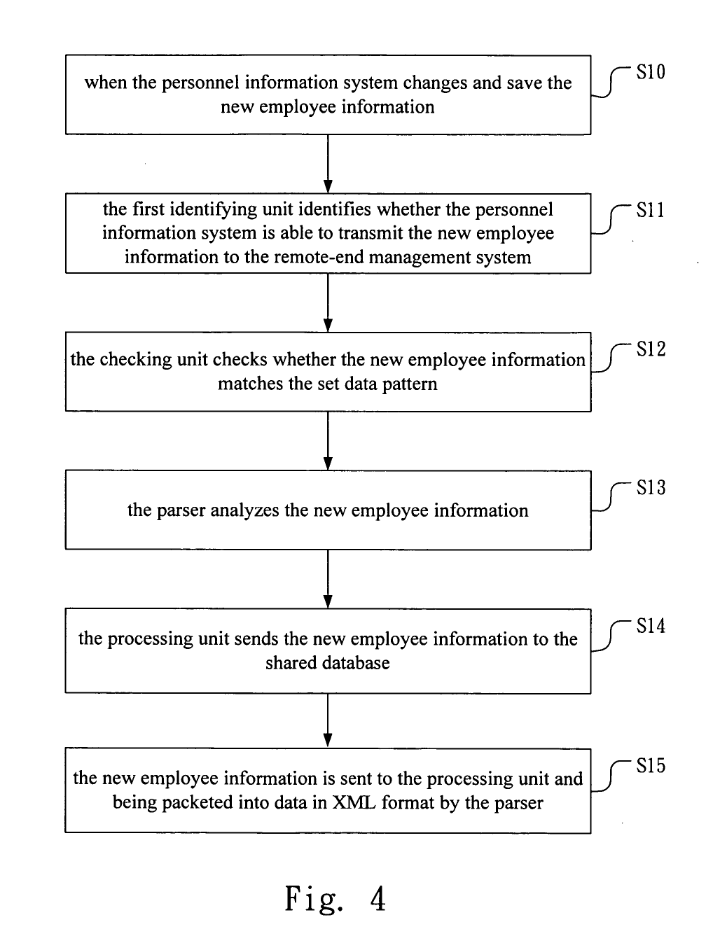

Referring to FIG. 4 in view of FIG. 3, in step S10, when a user wants to update the new employee information 100 to the shared database 30 by the remote management system 20, the new employee information 100 is sent to the shared database 30 by the remote management system 20. Proceeding to step S11, the first identifying unit 200 identifies whether the new employee information 100 is transmitted to the remote management system 20 for confirming the service type of the new employee information 100. Proceeding to step S12, the checking unit 202 checks whether the service type of the new employee information 100 corresponds to service type of the organization hierarchy system 40 and the salary management system 50. As shown in step S13, the parser 204 analyzes the new employee information 100 so as to recognize its item name and the content. Once the new employee information 100 is encrypted, it is also decrypted by the parser 204. Referring to step S14, the processing unit 206 sends the new employee information 100 to the shared database 30 for storing the new employee information 100 in the shared database 30.

Then proceeding to step S15, the new employee information 100 is sent to the processing unit 206 and being packeted into data with XML format by the parser 204. Then the second identifying unit 208 identifies whether the organization hierarchy system 40 and the salary management system 50 are subjects of the new employee information 100 for real-time transmitting the new employee information 100 to the organization hierarchy system 40 and the salary management system 50. Therefore, the disadvantage of conventional organization hierarchy system 40 and the salary management system 50 that periodically read the updated data according to a scheduled preset. Thus the organization hierarchy system 40 and the salary management system 50 can get the new employee information 100 in time.

Moreover, when data in the organization hierarchy system 40 or the salary management system 50 is modified, the modified data is sent to the remote management system 20 for storing the modified data to the shared database 30 in above way. The data is transmitted into the personnel information system 10 by the remote management system 20 in real time. Furthermore, the above personnel information system (the first system), the organization hierarchy system (the second system) and the salary management system (the second system) are applied in an embodiment of the present invention. They can be replaced or adjusted by accounting management system, research & development data exchange management system, marketing management system, customer data management system, even legal-related contract management system, and patent/trademark management system according to requirements of the company. The first system and the second system respectively include at least one system. The first system and the second system may vary according to different embodiments.

In summary, the present invention relates to a real-time data exchange system and method thereof that provides a remote management system as a data exchange medium of the personnel information system 10 (the first system) and the organization hierarchy system 40 or the salary management system 50 (the second system). Therefore, the shared database 30 is controlled by the remote management system so as to avoid database safety-related problems caused by directly accessing the new employee information 100 of the personnel information system 10 (the first system) to the shared database 30. Moreover, the new employee information is sent to the organization hierarchy system 40 and the salary management system 50 (the second system) in time by the remote management system 20 of the present invention so as to keep information consistency between different systems through internet or intranet.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A real-time data exchange system used for database security comprising:
a first system;
a shared database;
a second system; and
a remote-end management system, connected to the first system, the second system and the shared database;
wherein data of the first system is transmitted to the shared database by the remote management system for ensuring secure transmission, and the data real-time stored in the shared database is sent to the second system for ensuring consistency of the first system and the second system.

2. The system as claimed in claim 1, wherein the remote management system comprises a processing unit for processing executions between the remote management system and the shared database.

3. The system as claimed in claim 1, wherein remote management system comprises a checking unit for confirming whether service type of the data corresponds to service type of the second system.

4. The system as claimed in claim 1, wherein the remote management system comprises a parser for analyzing the data to recognize the data's name and content.

5. The system as claimed in claim 1, wherein the remote management system is a web server.

6. The system as claimed in claim 1, wherein the remote management system uses Transmission Control Protocol/Internet Protocol (TCP/IP) as a communication protocol.

7. A method for real-time data exchange comprising the steps of:
providing data to a remote management system by a first system;
sending the data to a shared database by the remote management system for storing the data in the shared database; and
real-time sending the data stored in the shared database to a second system by the remote management system while storing the data into the shared database.

8. The method as claimed in claim 7, wherein the step of sending the data from the remote management system to the shared database comprising an identifying step for identifying whether the first system is able to transmit the data to the remote management system.

9. The method as claimed in claim 7, wherein the step of sending the information from the remote management system to the shared database comprising a checking step for confirming whether service type of the data corresponds to service type of the second system.

10. The method as claimed in claim 7, wherein the step of sending the information from the remote management system to the shared database comprises a parsing step for analyzing the data to recognize the data's name and content.

11. The method as claimed in claim 10, wherein the parsing step comprises decrypting the data if the data is encrypted.

12. The method as claimed in claim 7, wherein the step of sending the data to a second system in real time by the remote management system comprising a step of packeting the data format.

13. The method as claimed in claim 7, wherein packet format of the data is Extensible Makeup Language (XML) format.

14. The method as claimed in claim 7, wherein the step of real-time sending the data to a second system by the remote management system comprises a step of identifying whether the second system is a delivery subject of the data.

15. The method as claimed in claim 7, wherein the remote management system uses Transmission Control Protocol/Internet Protocol (TCP/IP) as a communication protocol.
